(19) United States
(12) Patent Application Publication
(10) Pub. No.: US 2011/0168158 A1
(43) Pub. Date: Jul. 14, 2011

(54) TEMPERATURE INDICATOR

(76) Inventor: Sydney BARKHOUSE, Oakville (CA)

(21) Appl. No.: 12/986,541

(22) Filed: Jan. 7, 2011

Related U.S. Application Data
(60) Provisional application No. 61/293,384, filed on Jan. 8, 2010.

(51) Int. Cl. A47J 37/00

(52) U.S. Cl. 126/25 R

(57) ABSTRACT

A temperature indicator for an outdoor barbeque is disclosed. The temperature indicator may include a controller, a sensor and a visual indicator. The sensor may measure the temperature of a cooking area of the barbeque and communicate the measured temperature to the controller. The visual indicator may be coupled to the controller and may indicate the range of the measured temperature of the cooking area.

### CROSS-REFERENCE TO RELATED APPLICATIONS

The present application claims priority from U.S. Provisional Patent Application No. 61/293,384, filed Jan. 8, 2010, the entirety of which is hereby incorporated by reference.

### FIELD OF TECHNOLOGY

The present disclosure is related to temperature indicators, in particular temperature indicators suitable for use in consumer barbeques.

### BACKGROUND

A user of a consumer barbeque may desire to know the temperature of the barbeque grill. The temperature may be taken by using an extra thermometer. However, it may be cumbersome to use an extra thermometer when grilling on the barbeque, and opening/closing of the barbeque lid repeatedly to check on the temperature of the grill may result in undesirable loss of heat in the barbeque. The temperature indicated by the thermometer may also be difficult to understand at a glance.

### SUMMARY

What is described is a temperature indicator, which may be suitable for use in an outdoor barbeque. The temperature indicator may be provided in an upper closure member (e.g., the lid) of the barbeque, or other suitable location on the barbeque. In some examples, the temperature indicator may be used with a thermocouple and/or other suitable thermometers (e.g., a meat thermometer).

In some aspects, there is provided a temperature indicator for an outdoor barbeque, the barbeque having uninsulated upper and lower closure members for enclosing a cooking area, the cooking area including a grill disposed generally horizontally within the cooking area, and the upper closure member including a handle for moving the upper closure member to enclose the cooking area in a closed position and to provide access to the cooking area in an open position, the temperature indicator comprising: a controller mounted on the barbeque; a sensor provided on an inside of one of the closure members and positioned to measure a temperature of the cooking area, the sensor being in electric communication with the controller; and a visual indicator mounted on the handle of the upper closure member, the visual indicator being coupled to the controller for visually highlighting one of a plurality of temperature ranges, each of the plurality of temperature ranges being associated with a respective different visual highlight, the one temperature range being determined by the controller based on the measured temperature of the cooking area.

### BRIEF DESCRIPTION OF THE DRAWINGS

FIG. 1 shows top, front, bottom, side and perspective views of an example temperature indicator implemented in an upper closure member of a barbeque;

FIG. 2 shows top, front, perspective and exploded views of the example temperature indicator of FIG. 1, implemented in a handle of an upper closure member of a barbeque;

FIG. 3 is a front view of an example temperature indicator implemented in an upper closure member of a barbeque;

FIG. 4 is a close up view of the example temperature indicator of FIG. 3; and

FIGS. 5A-5D show example visual indicators suitable for use with an example temperature indicator.

### DETAILED DESCRIPTION

The temperature indicator of the present disclosure may be suitable for use on an outdoor barbeque. For example, the barbeque may include upper and lower closure members for enclosing a cooking area. The cooking area may include at least one grill, which may be positioned horizontally within the cooking area. The cooking area may refer to the surface of the grill, as well as the space surrounding the grill and within the enclosure when the upper and lower closure members are closed. The upper closure member may be referred to as a lid, and may include a handle for opening and closing the upper closure member, to provide access to the cooking area and the grill.

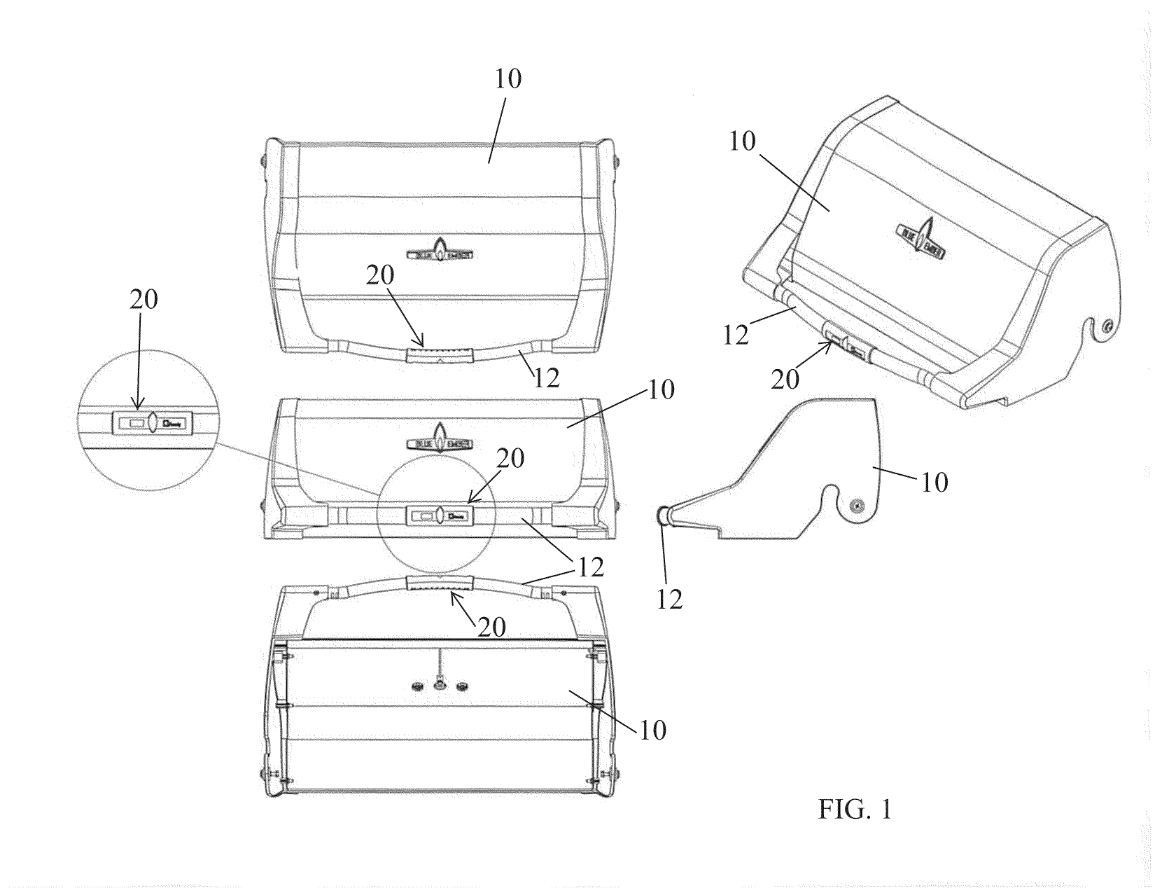

FIG. 1 shows an example temperature indicator 20 that is implemented on an upper closure member, such as a lid 10, of a barbeque, for example on a handle 12 of the lid 10. When the lid 10 is closed, the grill is enclosed within the lid 10 and the body of the barbeque.

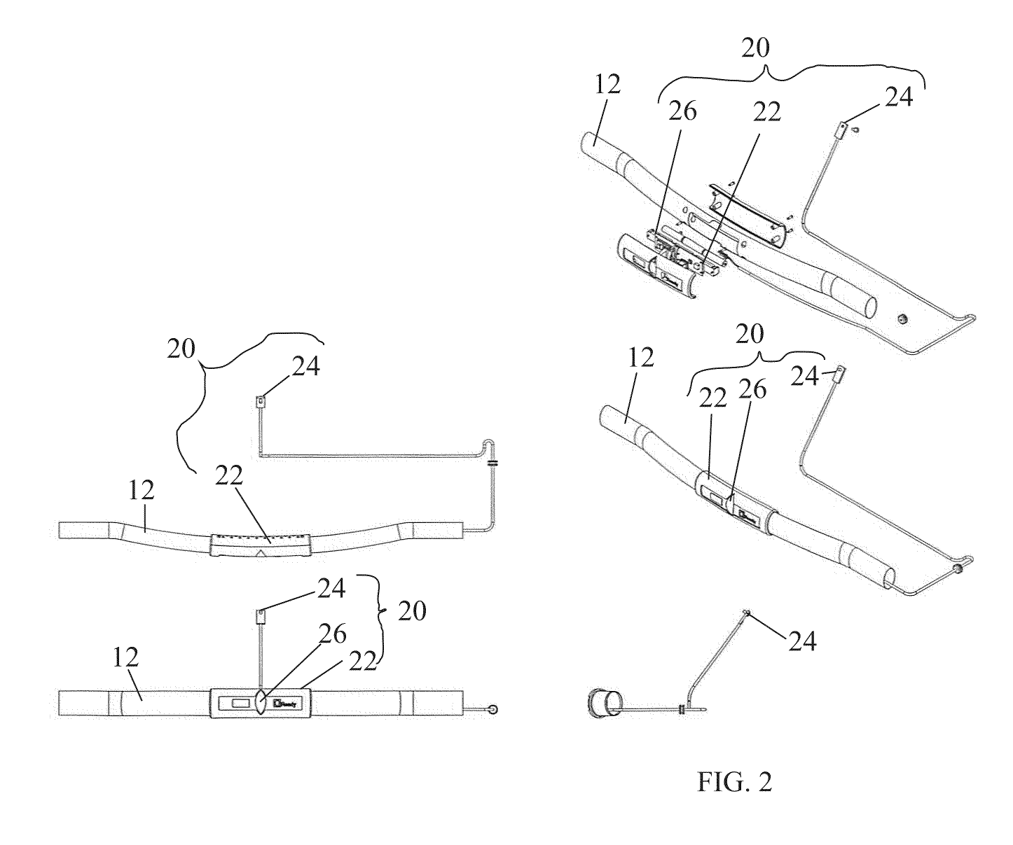

FIG. 2 shows the example temperature indicator 20 in more detail. In this example, the temperature indicator 20 includes a controller 22 mounted on the barbeque, a sensor 24 (for example, a temperature sensor), and a visual indicator 26.

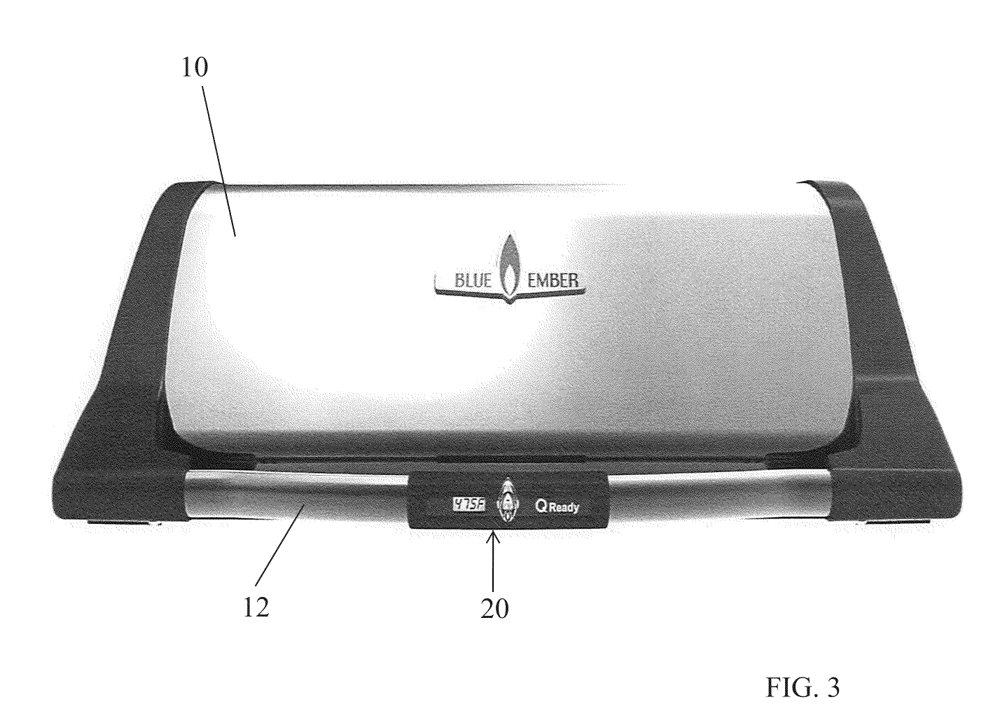

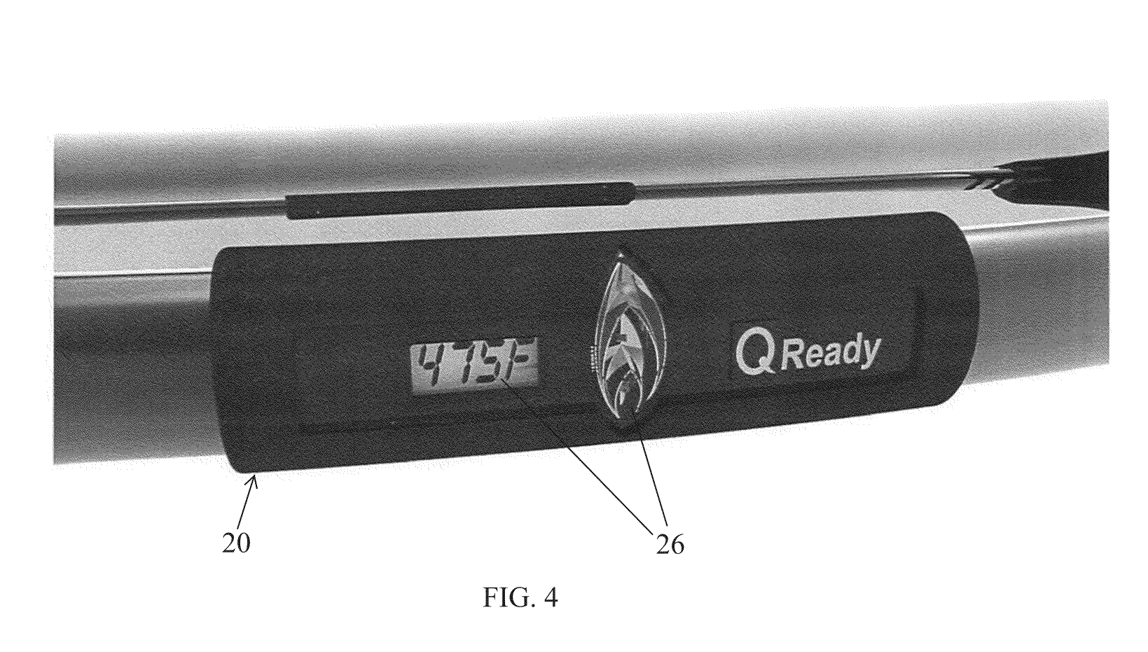

FIGS. 3 and 4 also show example temperature indicators 20 implemented on the lid 10.

In some examples, the temperature indicator 20 may be implemented in the lid 10 of the barbeque, with the controller 22 and visual indicator 26 being on the handle 12 of the lid 10. In the examples shown, the sensor 24 may be positioned within or under the lid 10 of the barbeque, for example such that the sensor 24 is located over the middle of the grill area when the lid 10 is closed. In some examples, the sensor 24 may be positioned outside of the lid 10, for example on the outside surface of the lid 10. In some examples, the sensor 24 may be positioned at any location on or near the lid 10 and/or the grill area, provided that the sensor 24 is able to sense at least some data (e.g., at least some emitted heat and/or light energy from the cooking area, or at least some energy produced by the barbeque) indicative of the temperature of the cooking area. In this example, the sensor 24 may be connected to the controller 22 by wiring, for transmitting measured temperature information to the controller 22, and the wiring in some examples may run from the lid area through the lid handle 12 to the controller 22. In other examples, the sensor 24 may communicate wirelessly with the controller 22.

In some examples, the sensor 24 (e.g., a thermocouple) may measure the temperature surrounding the barbeque grill and within the enclosure when the lid 10 is closed. In some examples, the visual indicator 26 may be controlled by the controller 22 and may visually show the sensed temperature and/or the range within which the sensed temperature falls.

In some examples, the temperature indicator 20 may also be provided elsewhere on the barbeque, for example on a barbeque console or a shelf of the barbeque (not shown). The temperature indicator 20 may be provided as a positionable or mobile component, which may be positioned anywhere on the barbeque or may be carried by a user, for example.

Although a thermocouple is described as an example of the sensor 24, other types of sensors may be suitable, including, for example, resistance temperature detectors (RTDs) or thermisters. In other examples, the sensor 24 may be positioned elsewhere on the barbeque, for example other locations under or within the lid 10, over or under the grill or in contact with the grill, and may be calibrated accordingly to reflect the grill's actual temperature. In examples where the controller 22 and/or visual indicator 26 are provided on the barbeque at locations other than the handle 12, the temperature sensor 24 may be positioned and calibrated accordingly.

In some examples, the sensor 24 may be moveable by the user to different positions, for example over different areas of the grill. In some examples, there may be more than one sensor 24 that communicates with the controller 22. In such examples, the controller 22 may allow the user to select the sensor 24 of interest from a plurality of available sensors 24. For example, different sensors 24 may provide temperature measurements over different areas of the grill and the controller 22 may provide an option to select which area of the grill should be monitored for temperature. Alternatively or in addition, the controller 22 may use temperature measurements received from two or more sensors 24 (e.g., in different positions over the grill) to calculate, for example, an average temperature of the grill.

In some examples, there may be a plurality of temperature indicators 20 on a barbeque, such as where the barbeque is sufficiently large and/or compartmentalized that different sections of the cooking area may have independently controllable and/or detectably different temperatures (e.g., upper and lower grilling racks, left and right sides of the grill, or combinations thereof).

In some examples, the sensor 24 may transmit sensed temperature measurements to the controller 22 wirelessly (e.g., using Bluetooth or other suitable wireless technologies), such as where the controller 22 is mobile. The sensor 24 may be particular to the temperature indicator 20 or the sensor 24 may be any suitable conventional thermal sensor.

In some examples, the visual indicator 26 may include a plurality of lights, for indicating or visually highlighting a certain range of temperature as measured by the sensor 24.

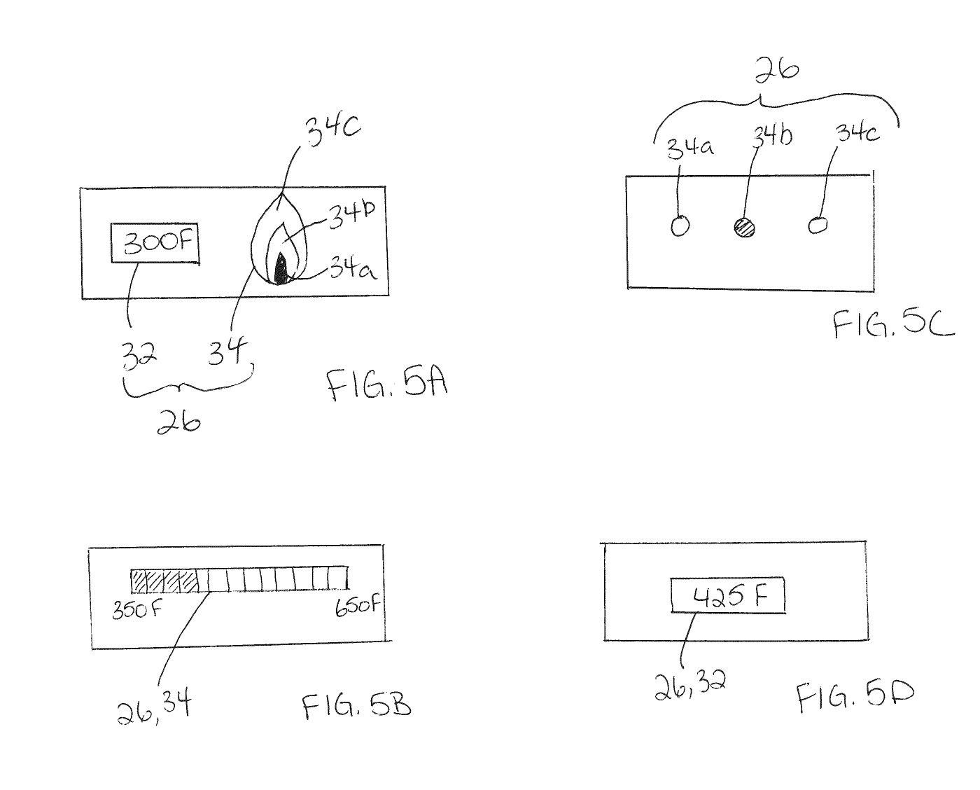

For example, as shown in FIG. 5A, the visual indicator 26 may include a numerical indicator 32 (e.g., a digital display or an analog gauge) showing the approximate temperature of the grill, as sensed by the sensor 24. In some examples, the numerical indicator 32 may be selected to display temperature in Celsius or in Fahrenheit (e.g., using a selection button on the controller 22). Where the temperature indicator 20 includes both the numerical indicator 32 and the visual indicator 26, the user may be provided with an option (e.g., using a selection button on the controller 22) to activate only the numerical indicator 32, only the visual indicator 26, or both.

The visual indicator 26 may also include one or more lights 34, for visually highlighting a temperature range measured by the sensor 24. For example, the visual indicator 26 may include three lights 34a, 34b, 34c configured in a flame shape, although other numbers and configurations of lights may also be suitable (e.g., a row of lights, a column of lights, etc.). In this example, the lights 34a, 34b, 34c may be illuminated in different colours, each corresponding to a different temperature range, however the lights 34a, 34b, 34c may have the same colour and may visually highlight temperature ranges in a suitably modified manner (e.g., the number of lights lit up may correspond to different temperature ranges). In the example of FIG. 5A, each light 34a, 34b, 34c may correspond to a different temperature range, for example an orange light 34a may light up when the temperature sensor senses that the grill is in the temperature range of about 0 to 350 degrees F.; a blue light 34b may light up when the grill is sensed to be in the temperature range of about 350 to 550 degrees F.; and a red light 34c may light up when the grill is sensed to be in the temperature range of about 550 to 650 degrees F.

In some examples, the lights 34a, 34b, 34c may cumulatively light up (e.g., at a temperature range of about 350 to 550 degrees F., both the orange light 34a and the blue light 34b may light up) or may exclusively light up (e.g., at a temperature range of about 350 to 550 degrees F., only the blue light 34b may light up).

Although certain temperature ranges and a certain number of ranges have been described, other temperature ranges and other numbers of ranges may be used. For example, the temperature ranges may be defined to suit different types of food best cooked in a given temperature range (e.g., about 250 to 350 degrees F. may be suitable for cooking fish and vegetables, about 350 to 450 degrees F. may be suitable for cooking white meat, and about 450 to 550 degrees F. may be suitable for cooking other meats), different types of cooking methods (e.g., about 200 to 300 degrees F. may be suitable for low temperature cooking, about 300 to 400 degrees F. may be suitable for roasting, about 400 to 500 degrees F. may be suitable for normal grilling, and about 500 to 650 degrees F. may be suitable for hot grilling), or a combination thereof. In some examples, the temperature indicator 20 may be programmable by the user to define the temperature ranges indicated by the visual indicator 26. For example, a user who only does low temperature cooking may prefer the visual indicator 26 to indicate temperature ranges of about 0 to 150 degrees F., about 150 to 250 degrees F., and about 250 degrees F. and higher.

The visual indicator 26 may be suitably configured to accommodate the variations described above. For example, the visual indicator 26 may have lights 34a, 34b, 34c that correspond in color to the type of food best cooked in a given temperature range, such as a red light for the temperature range of about 450 to 550 degrees F., which may be suitable for cooking red meat, an orange light for the temperature range of about 350 to 450 degrees F., which may be suitable for cooking white meat, and a green light for the temperature range of about 250 to 350 degrees F., which may be suitable for cooking vegetables. The different temperature ranges may be progressively different (e.g., in ranges of increasing temperature) and each may be associated with a different visual highlight (e.g., progressive visual highlights, such as progressive lights).

Other configurations for the visual indicator 26 may be used. For example, FIG. 5B shows an example visual indicator 26 having a plurality of lights 34 in a row configuration, where the number of lights lit up may indicate the approximate temperature sensed. FIG. 5C shows an example visual indicator 26 having a plurality of lights 34a, 34b, 34c where the specific light lit up may indicate the approximate temperature or temperature range sensed. FIG. 5D shows an example visual indicator 26 having only a numerical indicator 32. Other such example configurations may be used, and such configurations may be used in combination.

In other examples, the visual indicator 26 may express any other suitable type of visual indication of the sensed temperature, for example as a change in position, angle, brightness, texture, colour, intensity, and/or shape, among others.

In some examples, the temperature indicator 20 may include a safety indicator (not shown) (e.g., a visual safety indicator such as a light, or an audio safety indicator such as a buzzer, or a combination thereof) that may activate if the sensed temperature of the grill exceeds a certain threshold (e.g., the temperature is above the range of about 550 to 650 degrees F.).

In some examples, the temperature indicator 20 may include a battery pack or other power source (not shown), and may include a power switch (e.g., provided on the controller 22) to turn on or off the temperature indicator 20. In some examples, the temperature indicator 20 may automatically turn on (e.g., when the barbeque is first ignited), and the temperature indicator 20 may have a timer to automatically switch off after a set time period (e.g., 30 minutes) in order to conserve battery power. Other suitable triggers for automatically turning the temperature indicator 20 on or off may also be used (e.g., closing of the lid 10). In some examples, the temperature indicator 20 may automatically turn on each time the lid 10 is opened or closed.

In some examples, the temperature indicator 20 may be used with a temperature probe, such as a meat probe or other suitable probes. The temperature probe may be any conventional probe or may be particular to the temperature indicator 20. The temperature indicator 20 may include a connector (e.g., an audio plug connection), which may be provided on the controller 22, for connecting the temperature probe, and may include any suitable additional probe indicator (e.g., an additional numerical temperature display and/or additional visual indicator) for indicating the temperature sensed by the temperature probe. Similar to the sensor 24, the temperature probe may transmit temperature measurements to the controller 22 through wired or wireless communication.

Some conventional temperature indicators may be, for example, analog temperature indicators that are positioned on the lid 10 of a barbeque and that directly measure the temperature of the lid 10, to approximate the temperature over the grill. The presently disclosed temperature indicator may provide a more accurate measurement of cooking temperature, by using a sensor 24 that is positioned within the lid 10, over the grill or in some other suitable position, to more accurately (e.g., directly) measure the temperature of the cooking area.

The positioning of the controller 22 and the temperature indicator 20 on the handle 12, in some examples, may be useful for avoiding thermal damage to the electronics of these components. The lid 10 of a barbeque may be uninsulated, and positioning of the controller 22 and the temperature indicator 20 directly on the lid 10 may overheat these components, causing damage or malfunction. The positioning of the temperature indicator 20 on the handle 12 may also be useful for providing easy visual access of temperature information to the user. For example, as the user lifts open the lid 10 of the barbeque, the temperature indicator 20 may be brought closer to the eyes of the user. This may allow the user to relatively easily and quickly determine the temperature of the cooking area before the lid 10 is fully opened, allowing the lid 10 to be quickly closed if the temperature is not high enough, for example.

In some examples, the use of a visual indicator 26 may be useful for providing at-a-glance information about the temperature of the cooking area of the barbeque. It may not be necessary for the user to know the precise temperature of the cooking area, only that the temperature falls within a certain range. For example, a user at a distance from the barbeque (e.g., up to 20, 40, 60, 80 feet or more) may relatively easily distinguish the different colors and/or lights showing on a visual indicator 26 and thus be informed of the general range of temperature of the cooking area. In some examples, the visual indicator 26 may be suitably adapted for temperature information to be easily distinguishable, even when viewed from a distance. For example, the visual indicator 26 may be suitably large (e.g., extending along or beyond the handle 12), may be suitably bright (e.g., having lights at about 1500 to 2000 lumen), and/or each temperature range may be indicated with suitably distinct shapes and/or colors (e.g., square, circle and triangle shapes and/or red, green and yellow colors). The configuration of the visual indicator 26 may depend on the intended maximum distance for viewing the visual indicator 26. Other embodiments may include other configurations of the visual indicator 26. Configurations such as those described above and elsewhere in the disclosure may be included in yet further embodiments.

In contrast, conventional temperature indicators that use gauges, dials or only numerical readouts may be hard or impossible to read at a distance (e.g., even at a distance of 10 feet), requiring close inspection by a user. Such conventional indicators may also be relatively easily obscured by grease from the food cooked in the barbeque. A user may also find it difficult to interpret the numerical information of a conventional indicator in terms of the suitability for cooking (e.g., a user may not know that 100 degrees F. is too low for grilling a steak), whereas a visual indication of the temperature range of the cooking area, as provided by the disclosed temperature indicator 20, may provide indication of the suitability of a cooking temperature (e.g., a green light for a low temperature range or for a temperature range suitable for cooking vegetables and a red light for a high temperature range or for a temperature range suitable for cooking meats).

In some examples, where a conventional temperature indicator having a gauge, dial or numerical readout is used with a conventional temperature probe (e.g., meat thermometer) also having a numerical readout, it may be difficult for a user to distinguish which temperature reading belongs to which sensor. In contrast, it may be relatively easy for a user to distinguish between the visual indicator 26 of the disclosed temperature indicator 20 and a readout from a temperature probe.

While certain example embodiments have been described and illustrated, it should be understood that these are provided only for the purpose of illustration and are not intended to be limiting. All values and sub-ranges within disclosed value ranges are also disclosed. Features and variations described in separate embodiments may be combined and/or included in yet further embodiments. All references mentioned are hereby incorporated by reference in their entirety.

1. A temperature indicator for an outdoor barbeque, the barbeque having uninsulated upper and lower closure members for enclosing a cooking area, the cooking area including a grill disposed generally horizontally within the cooking area, and the upper closure member including a handle for moving the upper closure member to enclose the cooking area in a closed position and to provide access to the cooking area in an open position, the temperature indicator comprising:
a controller mounted on the barbeque;
a sensor provided on an inside of one of the closure members and positioned to measure a temperature of the cooking area, the sensor being in electric communication with the controller; and
a visual indicator mounted on the handle of the upper closure member, the visual indicator being coupled to the controller for visually highlighting one of a plurality of temperature ranges, each of the plurality of temperature ranges being associated with a respective different visual highlight, the one temperature range being determined by the controller based on the measured temperature of the cooking area.

2. The temperature indicator of claim 1 wherein the visual indicator comprises a plurality of lights, each light corresponding to a different one of the plurality of temperature ranges, wherein each light is activated by the controller according to the one temperature range determined based on the measured temperature of the cooking area.

3. The temperature indicator of claim 1 further comprising a numerical indicator for indicating the measured temperature of the cooking area.

4. The temperature indicator of claim 1 wherein the sensor is a thermocouple.

5. The temperature indicator of claim 1 wherein the sensor communicates the measured temperature of the cooking area to the controller wirelessly.

6. The temperature indicator of claim 1 further comprising a connector for connecting to a temperature probe, the temperature indicator also comprising a probe indicator for indicating a probe temperature measured by the temperature probe.

7. The temperature indicator of claim 6 wherein the temperature probe is a meat probe.

8. The temperature indicator of claim 1 wherein there is a plurality of sensors, and the temperature range indicated is calculated from the measured temperatures from each of the plurality of sensors.

9. The temperature indicator of claim 1 wherein there is a plurality of sensors, the controller is configured to provide an option for selecting one of the plurality of sensors, and the temperature range indicated is based on the measured temperature measured by the selected one of the plurality of sensors.

10. The temperature indicator of claim 1 further comprising a safety indicator that is activated when the measured temperature exceeds a predetermined temperature threshold.

11. The temperature indicator of claim 10 wherein the safety indicator is a visual or audio indicator.

12. The temperature indicator of claim 1 further comprising a battery pack for providing a source of power.

13. The temperature indicator of claim 1 wherein the controller is configured to automatically turn on when the barbeque is ignited and to automatically turn off after a predetermined time period of no usage.

14. The temperature indicator of claim 1 wherein the controller is mounted on the handle of the upper closure member.

15. The temperature indicator of claim 1 wherein the plurality of temperature ranges, are progressively different temperature ranges, and each of the plurality of temperature ranges is associated with a respective different progressive visual highlight.

16. The temperature indicator of claim 1 wherein the visual indicator is brought to an eye-level of a user while the upper closure member is being moved to the open position.
